(19) United States
(12) Patent Application Publication
(10) Pub. No.: US 2025/0221586 A1
(43) Pub. Date: Jul. 10, 2025

(54) Child Toilet Ladder

(71) Applicant: Hui CHEN, Zhejiang (CN)

(72) Inventor: Hui CHEN, Zhejiang (CN)

(21) Appl. No.: 18/409,573

(22) Filed: Jan. 10, 2024

(51) Int. Cl. A47K 13/06; E06C 1/00

(52) U.S. Cl. CPC A47K 13/06; E06C 1/005

(57) ABSTRACT

A child toilet ladder comprises a ladder assembly and a cushion assembly, wherein the ladder assembly comprises a supporting platform, a height adjusting mechanism and an angle adjusting mechanism; the height adjusting mechanism comprises a main sleeve and a main rod, wherein the main rod is provided with a plurality of first locking holes, and the main rod is inserted into the main sleeve and connectedly locked by a first adjusting part; the angle adjusting mechanism comprises a supporting sleeve and a supporting rod, wherein a plurality of second locking holes are arranged on the supporting rod, and the supporting sleeve is sleeved on the supporting rod and is connectedly locked by a second adjusting part; through the angle adjusting mechanism, the main sleeve is rotatably connected with the supporting platform.

### TECHNICAL FIELD

The present invention relates to the technical field of children's sanitary products, in particular to a toilet ladder.

### BACKGROUND

At present, domestic toilets are all designed for adults. Both the height and the size of the toilet are relatively large. It is difficult for children to go up and down freely when using it, and it is also very tired to hang their feet after sitting on it; at the same time, because the inner ring of the toilet is relatively large, children will easily fall into the toilet if they are unstable, which is very unsafe. At present, there are toilet seats specially designed for children in the market. However, in the actual use process, because the height of each toilet seat is different, the toilet seat cannot be well adapted to the height of the toilet after buying it back, and the user needs to find something else to adapt to the toilet, which is very inconvenient to use.

China patent with application number of 201621372947 discloses an adjustable toilet device for children, which comprises a seat ring, a pedal and a support column. When in use, only the seat ring needs to be placed on the toilet seat and the support column needs to be placed on the ground, so that children can use it. However, the stability of the toilet device is not good, that is, when the seat of the toilet device is placed on the toilet seat, the seat is easy to slide off the toilet seat, which has potential safety hazards.

U.S. Pat. No. 17,885,415 discloses a toilet device for children, which comprises a seat, supporting feet and a bottom plate. Each support leg includes a main rod and an auxiliary rod, the upper end of the main rod is connected to one end of the base part, and the lower end is connected to one end of the bottom plate. The upper end of the auxiliary rod is connected with the main rod, and the lower end is connected with the other end of the bottom plate. However, the main rod and the auxiliary rod of the toilet are inserted into the bottom plate, so the adjustment of the main rod on the bottom plate cannot be realized, and it is not suitable for toilets with different heights, so the applicability is small.

Based on the above problems, there is a need for a brand-new toilet device for children. The device can be applied to toilets with different heights through a unique design. At the same time, the device also has an anti-slip function, which makes it difficult for the device to be separated from the toilet and has safety. The device also has the advantages of stable structure, comfort and convenience, which further improves the user's experience.

### SUMMARY

The present invention provides a child toilet ladder, which includes a ladder assembly and a cushion assembly, wherein the ladder assembly includes a supporting platform, a height adjusting mechanism and an angle adjusting mechanism; and
wherein the height adjusting mechanism includes a main sleeve and a main rod, wherein the main rod is provided with a plurality of first locking holes, and the main rod is inserted into the main sleeve and connectedly locked by a first adjusting part; and
wherein, the angle adjusting mechanism includes a supporting sleeve and a supporting rod, wherein the supporting rod is provided with a plurality of second locking holes, and the supporting sleeve is sleeved on the supporting rod and is connectedly locked by a second adjusting part; and
wherein, through the angle adjusting mechanism, the main sleeve is rotatably connected with the supporting platform, the supporting sleeve is detachably connected with the supporting platform, and the supporting rod is detachably connected with the height adjusting mechanism by the first adjusting part; a stable triangular structure is formed among the supporting platform, the height adjusting mechanism and the angle adjusting mechanism, and the cushion assembly is rotatably connected with the main rod, so that the ladder assembly and the cushion assembly are detachably connected.

The present invention further provides a child toilet ladder, which includes a ladder assembly and a cushion assembly, wherein the ladder assembly includes a supporting platform, a height adjusting mechanism and an angle adjusting mechanism; and
wherein the height adjusting mechanism includes a main sleeve and a main rod, wherein the main rod is provided with a plurality of first locking holes, and the main rod is inserted into the main sleeve and connectedly locked by a first adjusting part; and
wherein, the angle adjusting mechanism includes a supporting sleeve and a supporting rod, wherein the supporting rod is provided with a plurality of second locking holes, the supporting sleeve is sleeved on the supporting rod, and is connectedly locked by a second adjusting part, and at least part of the supporting sleeve has an arc-shaped tubular structure; and
wherein, through the angle adjusting mechanism, the main sleeve is rotatably connected with the supporting platform, the supporting sleeve is detachably connected with the supporting platform, and the supporting rod is detachably connected with the height adjusting mechanism through the first adjusting part; a stable triangular structure is formed among the supporting platform, the height adjusting mechanism and the angle adjusting mechanism, and the cushion assembly is rotatably connected with the main rod of the ladder assembly, so that the ladder assembly and the cushion assembly are detachably connected.

The present invention further provides a method for children to use an adult toilet, which includes providing a child toilet ladder, wherein
the child toilet ladder includes a ladder assembly and a cushion assembly, wherein the ladder assembly includes a supporting platform, a height adjusting mechanism and an angle adjusting mechanism; and
wherein the height adjusting mechanism includes a main sleeve and a main rod, wherein the main rod is provided with a plurality of first locking holes, and the main rod is inserted into the main sleeve and connectedly locked by a first adjusting part; and
wherein, the angle adjusting mechanism includes a supporting sleeve and a supporting rod, wherein the supporting rod is provided with a plurality of second locking holes, and the supporting sleeve is sleeved on the supporting rod and is connectedly locked by a second adjusting part; and
wherein, through the angle adjusting mechanism, the main sleeve is rotatably connected with the supporting platform, the supporting sleeve is detachably connected with the supporting platform, and the supporting rod is detachably connected with the height adjusting mechanism through the first adjusting part; a stable triangular structure is formed among the supporting platform, the height adjusting mechanism and the angle adjusting mechanism, and the cushion assembly is rotatably connected with the main rod, so that the ladder assembly and the cushion assembly are detachably connected; and
the method includes the following ladder:
placing the cushion assembly on a toilet; and
adjusting the child toilet ladder to a proper height relative to the toilet through the height adjusting mechanism; and
adjusting the child toilet ladder to an appropriate inclination angle relative to the toilet through the angle adjusting mechanism.

The terms “invention,” “the invention,” “this invention” and “the present invention” used in this patent are intended to refer broadly to all of the subject matter of this patent and the patent claims below. Statements containing these terms should be understood not to limit the subject matter described herein or to limit the meaning or scope of the patent claims below. Embodiments of the invention covered by this patent are defined by the claims below, not this summary. This summary is a high-level overview of various embodiments of the invention and introduces some of the concepts that are further described in the Detailed Description section below. This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings and each claim.

### BRIEF DESCRIPTION OF DRAWINGS

In order to explain the technical scheme of this application more clearly, the drawings needed in the implementation will be briefly introduced below. Obviously, the drawings described below are only some implementations of this application. For those skilled in the art, other drawings can be obtained according to these drawings without creative work.

FIG. 1 is a schematic diagram of a child toilet ladder in the application of the present invention;

FIG. 2 is a schematic diagram of the ladder assembly in the application of the present invention;

FIG. 3 is a schematic diagram of a supporting platform in the application of the present invention;

FIG. 4 is a schematic view of the lower pedal in the application of the present invention;

FIG. 5 is a schematic view of the supporting seat in the application of the present invention;

FIG. 6 is a schematic diagram of the height adjusting mechanism in the application of the present invention;

FIG. 7 is a schematic diagram of the main sleeve in the application of the present invention;

FIG. 8 is a schematic diagram of the main rod in the application of the present invention;

FIG. 9 is a schematic diagram of an angle adjusting mechanism in the application of the present invention;

FIG. 10 is a schematic view of the supporting sleeve in the application of the present invention;

FIG. 11 is a schematic diagram of a supporting rod in the application of the present invention;

FIG. 12 is a schematic diagram of the upper pedal in the application of the present invention;

FIG. 13 is a schematic view of the cushion assembly in the application of the present invention;

FIG. 14 is a schematic view of the toilet seat body in the application of the present invention;

FIG. 15 is a schematic diagram of the armrest in the application of the present invention.

In the drawings: Ladder assembly (1000); Supporting platform (1100); Lower pedal (1110); Connecting cavity (1111); Connecting through hole (1112); First convex part (1113); Anti-slip line (1114); Supporting seat (1120); Fixed cavity (1121); Connecting groove (1122); Convex structure (1123); Height adjusting mechanism (1200); Main sleeve (1210); Second convex part (1211); First connecting hole (1212); Main rod (1220); First locking hole (1221); First adjusting part (1222); Hinge hole (1223); Angle adjusting mechanism (1300); Supporting sleeve (1310); Clamping block (1311); Second connecting hole (1312); Supporting rod (1320); Second locking hole (1321); Second adjusting part (1322); Third connecting hole (1323); Upper pedal (1400); Fourth connecting hole (1410); Cushion assembly (2000); Toilet seat body (2100); Fifth connecting hole (2110); First fixing groove (2120); Armrest (2200); First bump (2210); Backrest (2400); Cushion (2500); Limit block (2600).

### DESCRIPTION OF EMBODIMENTS

In describing the preferred embodiments, specific termi-nology will be resorted to for the sake of clarity. It is to be understood that each specific term includes all technical equivalents which operate in a similar manner to accomplish a similar purpose.

While various aspects and features of certain embodiments have been summarized above, the following detailed description illustrates a few exemplary embodiments in further detail to enable one skilled in the art to practice such embodiments. Reference will now be made in detail to embodiments of the inventive concept, examples of which are illustrated in the accompanying drawings. The accompanying drawings are not necessarily drawn to scale. The described examples are provided for illustrative purposes and are not intended to limit the scope of the invention. It should be understood, however, that persons having ordinary skill in the art may practice the inventive concept without these specific details.

It will be understood that, although the terms first, second, etc. may be used herein to describe various elements, these elements should not be limited by these terms. These terms are only used to distinguish one element from another. For example, a first attachment could be termed a second attachment, and, similarly, a second attachment could be termed a first attachment, without departing from the scope of the inventive concept.

It will be understood that when an element or layer is referred to as being “on,” “coupled to,” or “connected to” another element or layer, it can be directly on, directly coupled to or directly connected to the other element or layer, or intervening elements or layers may be present. In contrast, when an element is referred to as being “directly on,” “directly coupled to,” or “directly connected to” another element or layer, there are no intervening elements or layers present. Like numbers refer to like elements throughout. As used herein, the term “and/or” includes any and all combinations of one or more of the associated listed items.

As used in the description of the inventive concept and the appended claims, the singular forms “a,” “an,” and “the” are intended to include the plural forms as well, unless the context clearly indicates other.

As a preferred embodiment of the application of the present invention, in order to enable children to use adult toilets, the application of the present invention provides a child toilet ladder.

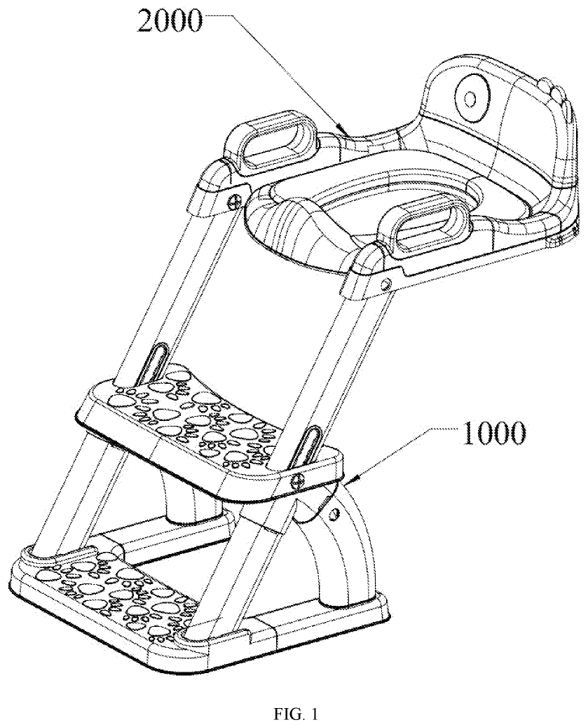

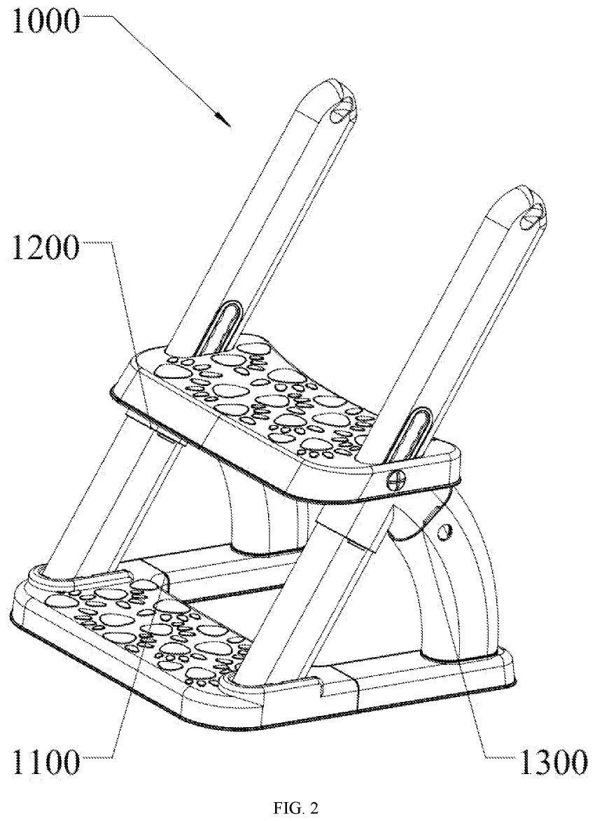

Referring to FIGS. 1 and 2, the child toilet ladder includes a ladder assembly 1000 and a cushion assembly 2000, wherein the ladder assembly 1000 includes a supporting platform 1100, a height adjusting mechanism 1200 and an angle adjusting mechanism 1300.

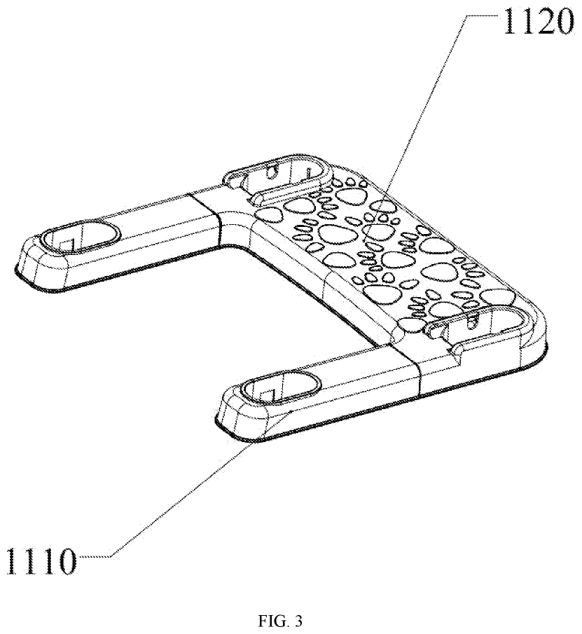

Referring to FIG. 3, the supporting platform 1100 includes a lower pedal 1110 and a supporting seat 1120, and the lower pedal 1110 and the supporting seat 1120 are detachably connected through a mortise and tenon structure. The mortise and tenon structure is a traditional joint method, in which the convex part of a component is called tenon and the concave part is called mortise. The most basic mortise and tenon structure consists of two components, the tenon of one of which is inserted into the mortise of the other to connect and fix the two components.

In other embodiments (not shown in the figure), the connection mode of the lower pedal 1110 and the supporting seat 1120 can also be a snap connection, or a magnetic connection, and may also be a threaded connection, a pin connection, or a connector connection or the like.

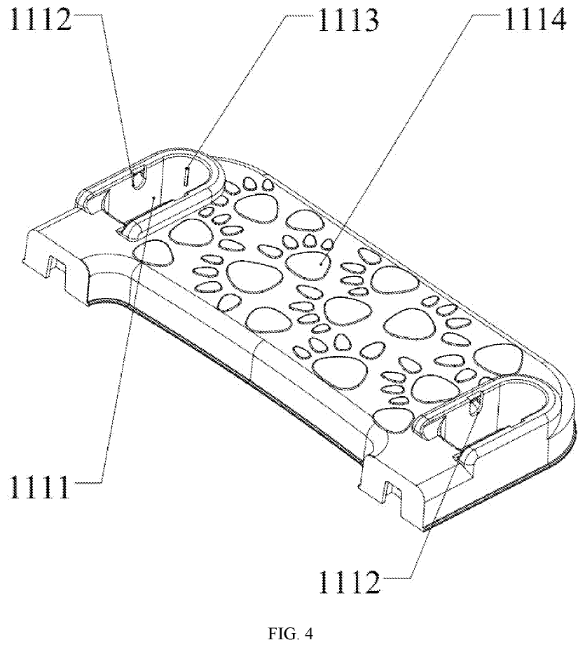

Referring to FIG. 4, the lower pedal 1110 is provided with a connecting cavity 1111, which is arranged at a section away from the supporting seat 1120, and both sides of the lower pedal 1110 are provided with connecting cavity 1111.

Further, the connecting cavity 1111 is internally provided with a symmetrical connecting through hole 1112 and at least one first convex part 1113. In this embodiment, the number of the first convex part 1113 is one, and the connecting through hole 1112 runs through the thickness of the lower pedal 1110, and both the connecting through hole 1112 and the first convex part 1113 are used for connecting and fixing with the main sleeve 1210.

In other embodiments (not shown in the figure), the number of the first convex part 1113 may be two, or three, or more.

Further, the surface of the lower pedal 1110 is provided with anti-slip lines 1114, which can provide greater friction when children pass the upper ladder of the lower pedal 1110, thus reducing the risk of children slipping and wrestling from the lower pedal 1110.

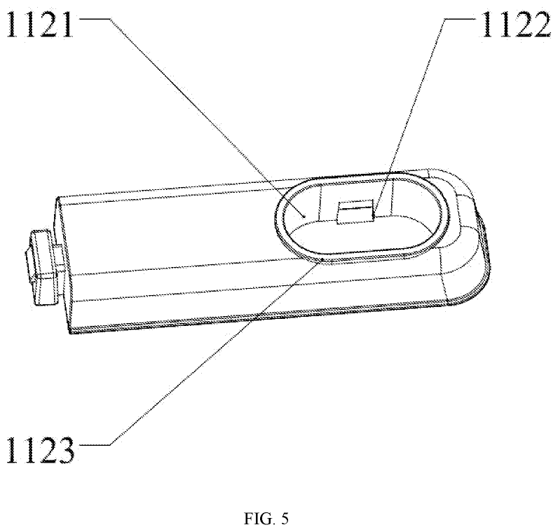

Referring to FIG. 5, the supporting seat 1120 has a fixed cavity 1121, which is arranged at one end far away from the lower pedal 1110, wherein the bottom of the fixed cavity 1121 is symmetrically provided with a connecting groove 1122 penetrating through the supporting seat 1120, and the fixed cavity 1121 extends upward to form a convex structure 1123. Both the connecting groove 1122 and the convex structure 1123 are used for connecting the supporting sleeve 1310, and the connection relationship between the connecting groove 1122 and the supporting sleeve 1310 is consolidated. Meanwhile, one end of the connecting groove 1122 has a protruding part, and the connection with the lower pedal 1110 is completed through the protruding part.

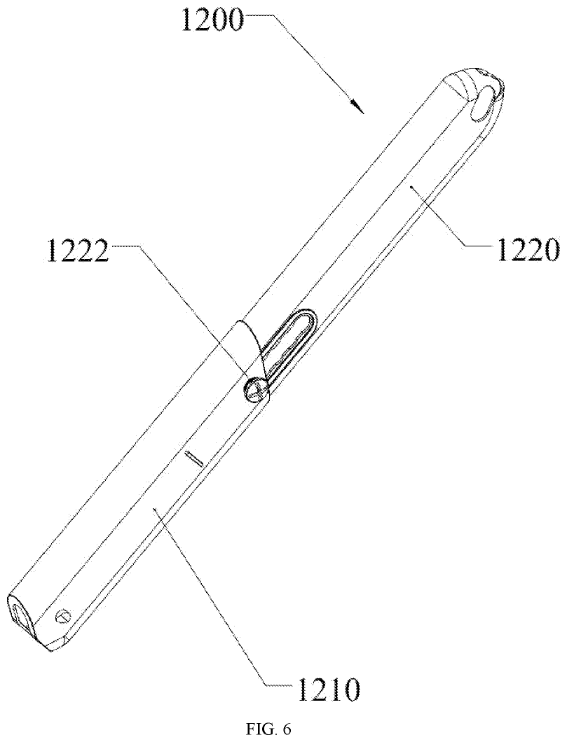

Referring to FIG. 6, the height adjusting mechanism 1200 includes a main sleeve 1210 and a main rod 1220, and the main sleeve 1210 and the main rod 1220 are connectedly locked by a first adjusting part 1222. In this embodiment, the first adjusting part 1222 is a bolt, and the main sleeve 1210 and the main rod 1220 are fixed by the bolt, so that the child toilet ladder are kept at a certain height. In other embodiments (not shown in the figure), the first adjusting part 1222 can also be a pin, or a key or other structural part for connection and limitation.

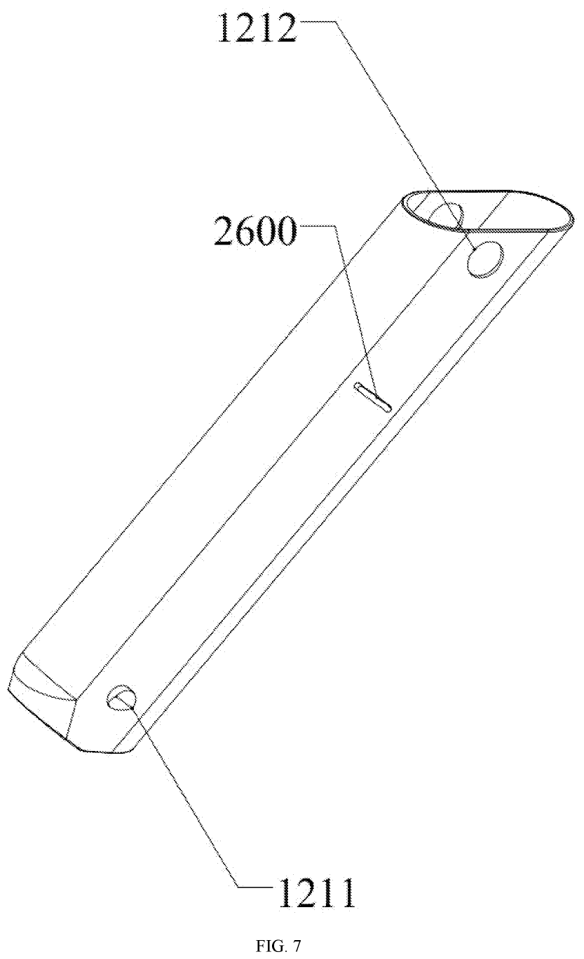

Referring to FIG. 7, one end of the main sleeve 1210 is provided with a second convex part 1211, which is matched with the connecting through hole 1112 of the lower pedal 1110, and can be clamped in the connecting through hole 1112; and at the same time, the middle part of the main sleeve 1210 is provided with a limit block 2600. The other end of the main sleeve 1210 is symmetrically provided with a first connecting hole 1212 for connecting the main rod 1220.

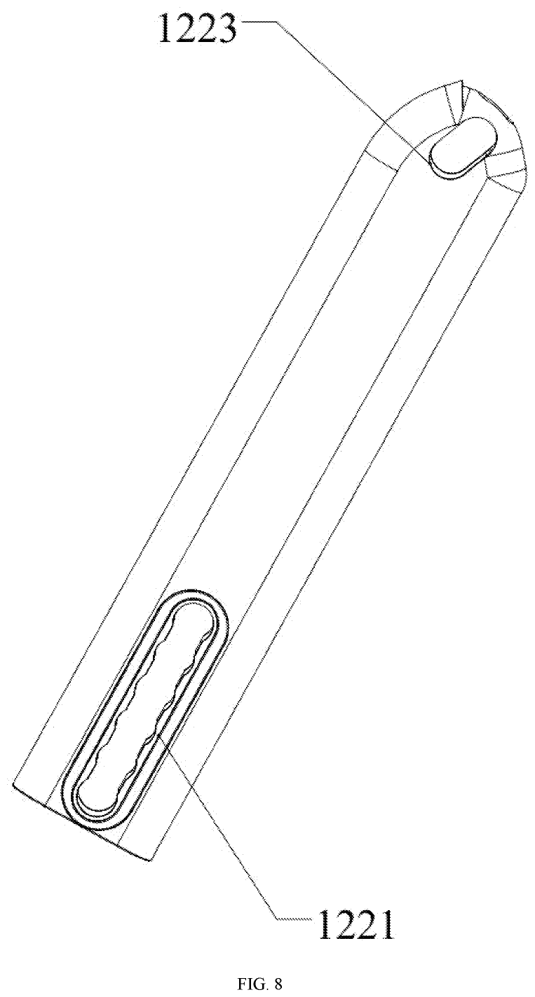

Referring to FIG. 8, the main rod 1220 is provided with a plurality of first locking hole 1221, and the first adjusting part 1222 passes through the first connecting hole 1212 and the first locking hole 1221 to connect and fix the main rod 1220 and the main sleeve 1210 together.

Specifically, the main rod 1220 is movably connected and fixed inside the main sleeve 1210, and the sizes of the first connecting hole 1212 and the first locking hole 1221 are the same. When the position of the first connecting hole 1212 coincides with the position of one of the first locking hole 1221, the main rod 1220 and the main sleeve 1210 can be connected through the first adjusting part 1222 to form limit fixation. At the same time, by making the position of the first connecting hole 1212 coincide with the position of the different first locking hole 1221, the height adjusting mechanism 1200 can be correspondingly extended or shortened.

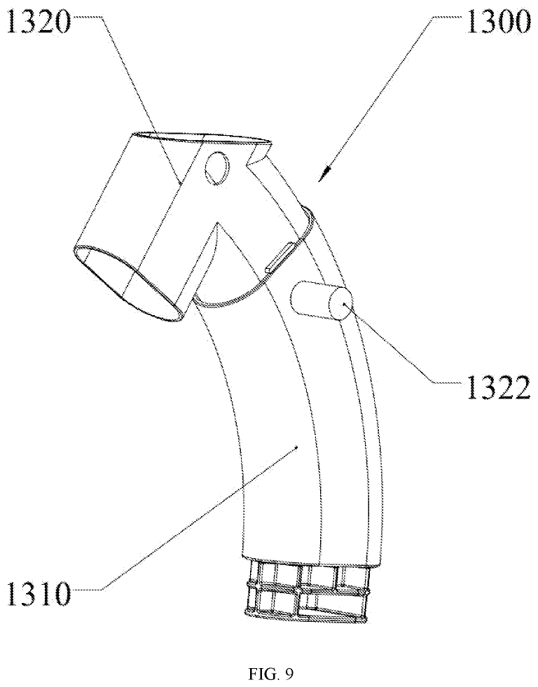

Referring to FIG. 9, the angle adjusting mechanism 1300 includes a supporting sleeve 1310 and a supporting rod 1320, and the supporting sleeve 1310 and the supporting rod 1320 are connectedly locked by a second adjusting part 1322. At the same time, a limit block 2600 is arranged in the middle of the supporting rod 1320, so that the ladder assembly 1000 can be adjusted within a certain angle.

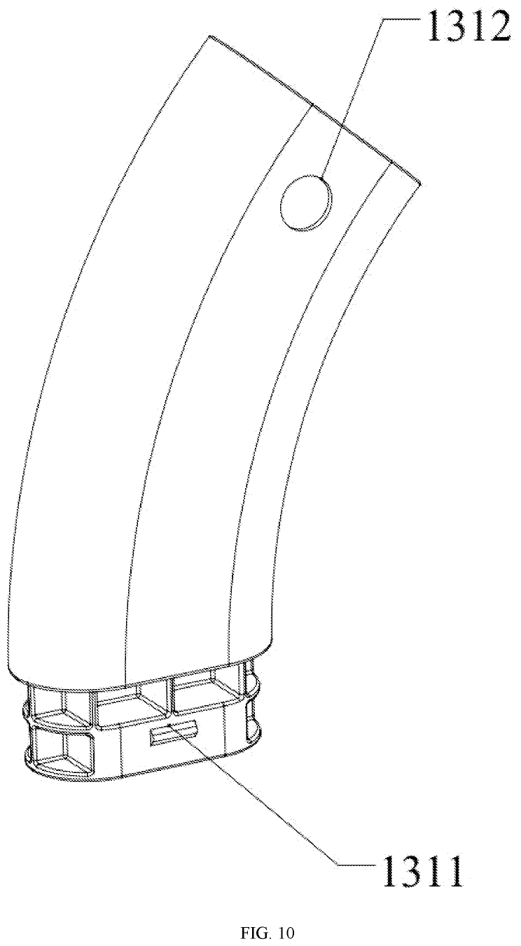

Referring to FIG. 10, one end of the supporting sleeve 1310 is provided with a clamping block 1311, and the other end is provided with a second connecting hole 1312. Through the clamping block 1311, the supporting sleeve 1310 can be fixed in the connecting groove 1122 of the fixed cavity 1121, so that the supporting sleeve 1310 and the supporting seat 1120 are connected and fixed. At least part of that supporting sleeve 1310 has an arc-shaped tubular structure.

In some embodiments (not shown in the figure), the supporting sleeve 1310 may be a straight tubular structure, an elliptical tubular structure, or a corrugated tubular structure and other shapes.

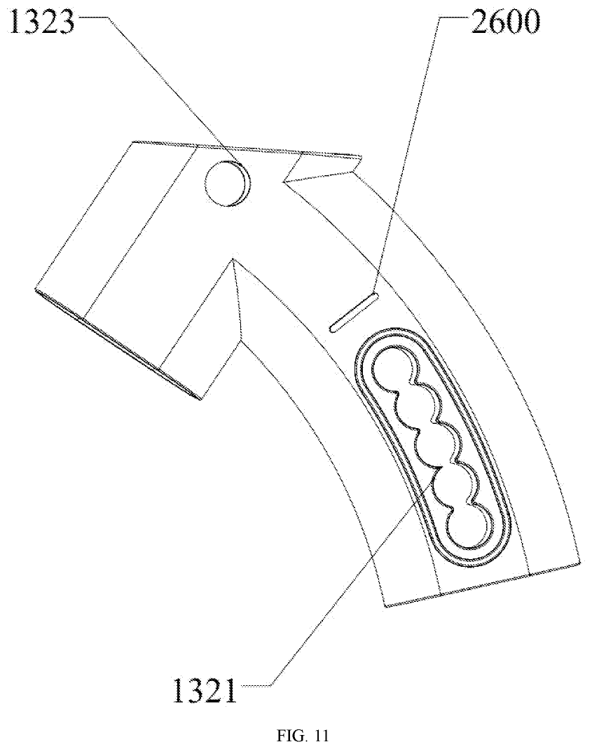

Referring to FIG. 11, the supporting rod 1320 is provided with a plurality of second locking hole 1321, and the second adjusting parts 1322 pass through the second locking hole 1321 and the second connecting hole 1312 to connect and fix the supporting sleeve 1310 and the supporting rod 1320 together.

Specifically, the supporting rod 1320 is movably connected and fixed inside the supporting sleeve 1310, and the second connecting hole 1312 has the same size as a plurality of second locking hole 1321. When the position of the second connecting hole 1312 coincides with the position of one of the second locking hole 1321, the supporting rod 1320 and the supporting sleeve 1310 can be connected through the second adjusting part 1322 to form a limiting fixation. At the same time, by making the position of the second connecting hole 1312 coincide with the position of the different second locking hole 1321, the child toilet ladder can be in different angle states.

Further, as shown in FIG. 2 and FIG. 11, the supporting rod 1320 is provided with a third connecting hole 1323, the first adjusting part 1222 is inserted into the third connecting hole 1323, and at least part of the main sleeve 1210 and the main rod 1220 is embedded in the supporting rod 1320.

Specifically, as shown in FIGS. 2 to 11, the supporting platform 1100 includes a lower pedal 1110 and a supporting seat 1120. The main sleeve 1210 is fixed in the connecting cavity 1111, and the first convex part 1113 plays a fixing role on the main sleeve 1210. The main sleeve 1210 is rotatably connected with the lower pedal 1110 with a rotation angle of not more than 90 degrees, and the supporting sleeve 1310 is detachably fixed in the fixed cavity 1121 of the supporting seat 1120. At the same time, the supporting rod 1320 is detachably connected with the height adjusting mechanism 1200 through the first adjusting part 1222, and the main sleeve 1210 and the main rod 1220 are partially fixed in the supporting rod 1320. The first adjusting part 1222 passes through the third connecting hole 1323 of the supporting rod 1320, the first locking hole 1221 of the main rod 1220 and the first connecting hole 1212 of the main sleeve 1210. A stable triangular structure is formed among the supporting platform 1100, the height adjusting mechanism 1200 and the angle adjusting mechanism 1300.

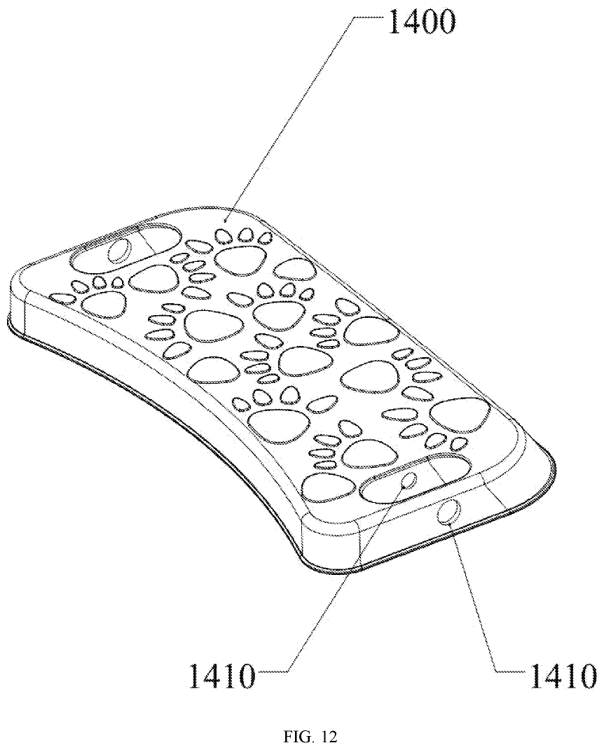

Further, as shown in FIGS. 2 and 12, an upper pedal 1400 is fixed at the joint of the height adjusting mechanism 1200 and the angle adjusting mechanism 1300, and fourth connecting holes 1410 are symmetrically arranged at both ends of the upper pedal 1400. The fourth connecting holes 1410 have the same size as the first locking hole 1221, and the upper pedal 1400 is connected and fixed to the height adjusting mechanism 1200 and the angle adjusting mechanism 1300 through the first adjusting part 1222.

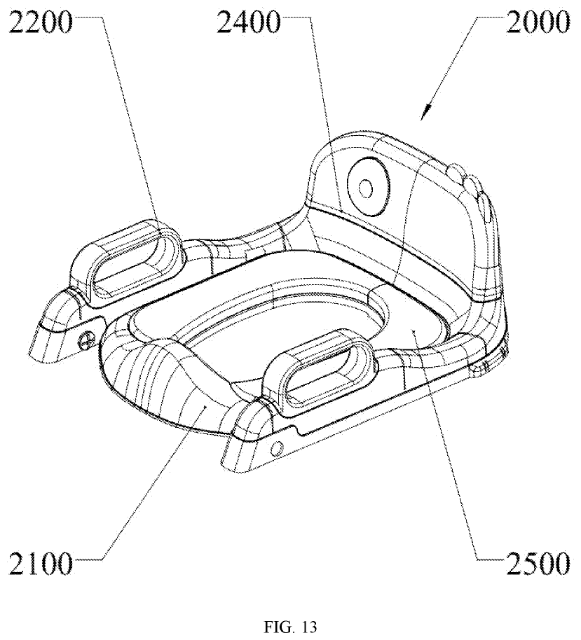

Referring to FIG. 13, the cushion assembly 2000 includes a toilet seat body 2100 and an armrest 2200, and the armrest 2200 is detachably connected with the toilet seat body 2100.

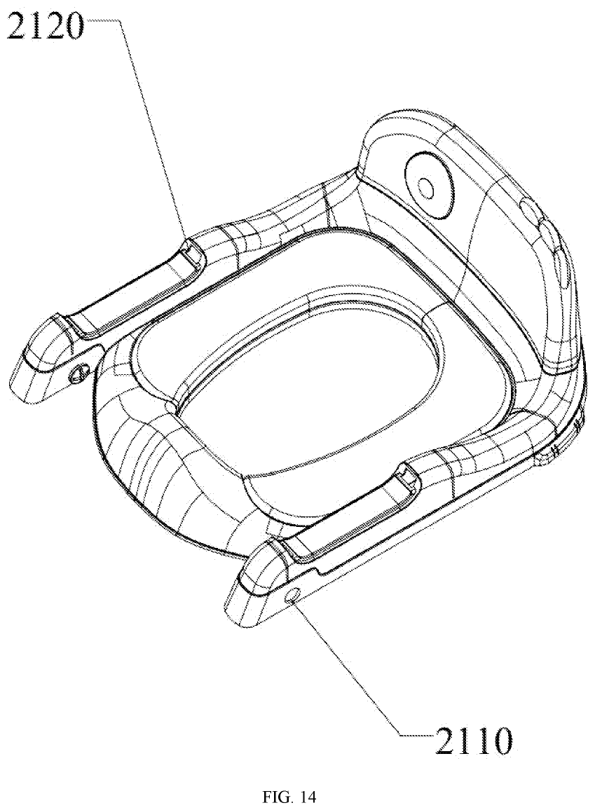

Referring to FIGS. 8 and 14, one end of the toilet seat body 2100 is provided with a fifth connecting hole 2110, and one end of the main rod 1220 is provided with a hinge hole 1223. The hinge hole 1223 has a chute structure, and the fifth connecting hole 2110 has the same size as the hinge hole 1223. A fastener is inserted into the fifth connecting hole 2110 and the hinge hole 1223, so that the toilet seat body 2100 and the main rod 1220 can be connected and fixed. The cushion assembly 2000 is rotatably connected with the main rod 1220 of the ladder assembly 1000, so that the ladder assembly 1000 and the cushion assembly 2000 are detachably connected.

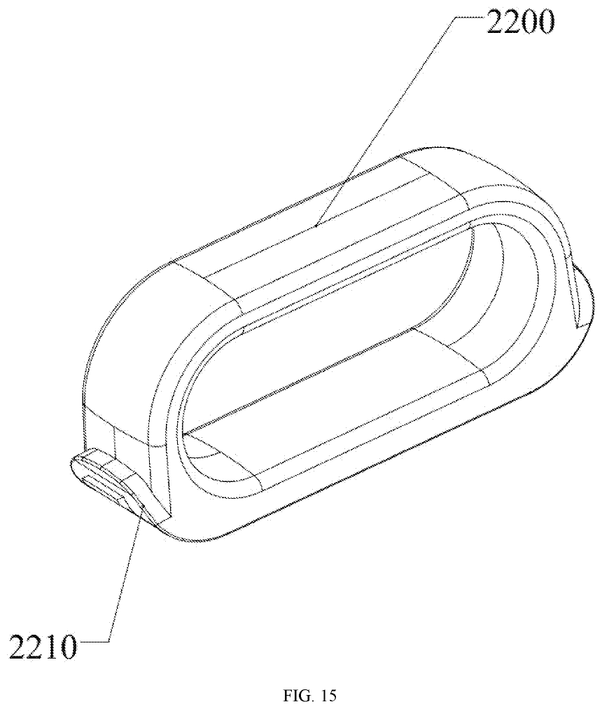

Further, as shown in FIGS. 14 and 15, at least four first fixing grooves 2120 are formed on both sides of the toilet seat body 2100, and first convex parts 2210 are symmetrically formed on both ends of the armrest 2200. The first convex parts 2210 are fixed in the first fixing grooves 2120, so that the armrest 2200 and the toilet seat body 2100 can be detachably connected.

Further, as shown in FIG. 13 and FIG. 14, a detachable cushion 2500 is added in the toilet seat body, and an anti-slip pad is arranged at the bottom, which is in contact with the toilet, so that the friction force is improved and the stability of the cushion assembly 2000 is increased. At the same time, the toilet seat body is connected with a backrest 2400, and the backrest and the toilet seat body are detachably connected by a snap.

In some embodiments (not shown in the figure), an adjustable heating device is arranged in the cushion 2500, and the heating device can adjust the appropriate temperature according to the different temperature requirements of children, so that children are more comfortable to use, and at the same time, a safety device is added to the toilet seat body 2100.

Referring to FIGS. 1 to 15, as a preferred embodiment of the present application, the present application also provides a method for children to use an adult toilet, including providing a child toilet ladder, which is mainly composed of a ladder assembly and a cushion assembly. The ladder assembly includes a supporting platform, a height adjusting mechanism and an angle adjusting mechanism, all of which are to ensure the safety and comfort of children when using the toilet.

First of all, the cushion assembly and the supporting platform are placed on the toilet and the ground respectively to ensure that the child toilet ladder will not be suspended during the adjustment process. The cushion assembly is specially designed for children, which is smaller than the cushion of the adult toilet and more suitable for children's body shape. This can prevent children from slipping when using the toilet and improve their safety.

Then, it needs to adjust the height of the child toilet ladder through the height adjusting mechanism to match the height of the toilet. The height adjusting mechanism usually includes a retractable lever and a locking device, which can be accurately adjusted according to the height of the child and the height of the toilet. In this way, children can easily climb the toilet without the help of adults.

Finally, it needs to adjust the tilt angle of the child toilet ladder through the angle adjusting mechanism to match the angle of the toilet. The angle adjusting mechanism usually includes a rotatable connector and a locking device, which can be accurately adjusted according to the shape and position of the toilet. In this way, children can sit firmly on the toilet.

Generally speaking, this method for children to use the adult toilet enables children to use the toilet safely, comfortably and confidently by providing a child toilet ladder. This can not only help children develop good hygiene habits, but also reduce the burden of parents' care. At the same time, this method can also help children improve their self-care ability and have a positive impact on their growth.

In addition, the design of the child toilet ladder applied by the present invention has many advantages: the height and angle can be adjusted according to the height and comfort of children through the height adjusting mechanism and the angle adjusting mechanism; good stability: a stable triangular structure is formed among the supporting platform, the height adjusting mechanism and the angle adjusting mechanism, which increases the stability of the product; detachable design: the ladder assembly and the cushion assembly can be disassembled, which is convenient for cleaning and storage; training self-care ability: using the child toilet ladder can help children develop the correct habit of going to the toilet, and at the same time reduce the burden of parents' care; safety: the design takes into account the safety of children and avoids the possible safety problems when children use adult toilets; comfort: the design of the rotary connection between the cushion assembly and the main rod makes the cushion adjustable as required, providing better comfort; easy to train: the child toilet ladder is an effective carrier for training children to go to the toilet, helping children to gradually take off their diapers to prepare.

In the broad aspect of the application of the present invention, the child toilet ladder can be used in the following fields: family life, in which the child toilet ladder can help children to carry out toilet training and improve their self-care ability; or kindergartens and schools: in the bathrooms of kindergartens and schools, child toilet ladders can help children use adult toilets independently and reduce the burden of care for teachers: or a public place: in the toilets of public places such as shopping malls and restaurants, the child toilet ladder can be provided for children to use, which improves the parent-child friendliness of public toilets; or medical institutions: in hospitals, clinics and other medical institutions, the child toilet ladder can help children use the bathroom independently, reducing the care burden of medical staff; travel and outdoor activities: in travel and outdoor activities, a portable child toilet ladder can facilitate children to use the bathroom at any time.

Therefore, compared with the traditional toilet device for children, the toilet ladder for children provided by the application of the present invention can be suitable for toilets with different heights through a unique design; at the same time, the device also has an anti-slip function, so that the device is not easy to be separated from the toilet, and has the advantages of stable structure, comfort, convenience and the like, and further improves the user's experience.

The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list. The use of “adapted to” or “configured to” herein is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or values beyond those recited. Similarly, the use of “based at least in part on” is meant to be open and inclusive, in that a process, step, calculation, or other action “based at least in part on” one or more recited conditions or values may, in practice, be based on additional conditions or values beyond those recited. Headings, lists, and numbering included herein are for ease of explanation only and are not meant to be limiting.

The various features and processes described above may be used independently of one another or may be combined in various ways. All possible combinations and sub-combinations are intended to fall within the scope of the present disclosure. In addition, certain method or process blocks may be omitted in some implementations. The methods and processes described herein are also not limited to any particular sequence, and the blocks or states relating thereto can be performed in other sequences that are appropriate. For example, described blocks or states may be performed in an order other than that specifically disclosed, or multiple blocks or states may be combined in a single block or state. The example blocks or states may be performed in serial, in parallel, or in some other manner. Blocks or states may be added to or removed from the disclosed examples. Similarly, the example systems and components described herein may be configured differently than described. For example, elements may be added to, removed from, or rearranged compared to the disclosed examples.

The invention has now been described in detail for the purposes of clarity and understanding. However, those skilled in the art will appreciate that certain changes and modifications may be practiced within the scope of the appended claims.

Conditional language used herein, such as, among others, “can,” “could,” “might,” “may,” “e.g.,” and the like, unless specifically stated otherwise, or otherwise understood within the context as used, is generally intended to convey that certain examples include, while other examples do not include, certain features, elements, and/or steps. Thus, such conditional language is not generally intended to imply that features, elements and/or steps are in any way required for one or more examples or that one or more examples necessarily include logic for deciding, with or without author input or prompting, whether these features, elements and/or steps are included or are to be performed in any particular example.

What is claimed is:

1. A child toilet ladder, comprising a ladder assembly and a cushion assembly, wherein said ladder assembly comprises a supporting platform, a height adjusting mechanism and an angle adjusting mechanism; and
wherein said height adjusting mechanism comprises a main sleeve and a main rod, wherein said main rod is provided with a plurality of first locking holes, and said main rod is inserted into said main sleeve and connectedly locked by a first adjusting part; and
wherein, said angle adjusting mechanism comprises a supporting sleeve and a supporting rod, wherein said supporting rod is provided with a plurality of second locking holes, and said supporting sleeve is sleeved on said supporting rod and is connectedly locked by a second adjusting part; and
wherein, through said angle adjusting mechanism, said main sleeve is rotatably connected with said supporting platform, said supporting sleeve is detachably connected with said supporting platform, and said supporting rod is detachably connected with said height adjusting mechanism by said first adjusting part; and a stable triangular structure is formed among said supporting platform, said height adjusting mechanism and said angle adjusting mechanism, and said cushion assembly is rotatably connected with said main rod, so that said ladder assembly and said cushion assembly are detachably connected.

2. The child toilet ladder according to claim 1, wherein said supporting platform comprises a lower pedal and a supporting seat, and said lower pedal and said supporting seat are detachably connected through a mortise and tenon structure.

3. The child toilet ladder according to claim 2, wherein said lower pedal has a connecting cavity, and said connecting cavity is arranged far away from said supporting seat, wherein both sides of said connecting cavity have symmetrically arranged connecting through holes and at least one first convex part, and said connecting through holes pass through said lower pedal.

4. The child toilet ladder according to claim 3, wherein a surface of said lower pedal is provided with anti-slip lines, and a rotation angle between said lower pedal and said main rod is not more than 90 degrees.

5. The child toilet ladder according to claim 4, wherein said supporting seat has a fixed cavity, which is arranged far away from said lower pedal, wherein a bottom of said fixed cavity is symmetrically provided with connecting grooves penetrating through said supporting seat, and said fixed cavity extends upward to form a convex structure.

6. The child toilet ladder according to claim 5, wherein one end of said main sleeve is provided with a second convex part which is matched with said connecting through hole, and the other end is symmetrically provided with a first connecting hole; and said main sleeve is fixed in said connecting cavity, and said first convex part plays a fixing role on said main sleeve.

7. The child toilet ladder according to claim 6, wherein said main rod is movably connected and fixed inside said main sleeve, said first connecting hole has a same size as the plurality of first locking holes, and said first adjusting part is inserted inside said plurality of first locking holes and said first connecting hole to form limit fixation.

8. The child toilet ladder according to claim 7, wherein one end of said supporting sleeve is provided with a clamping block, and the other end is provided with a second connecting hole, wherein said clamping block is fixed in said connecting groove so that said supporting sleeve and said supporting seat are connected and fixed.

9. The child toilet ladder according to claim 8, wherein said supporting rod is movably connected and fixed inside said supporting sleeve, said second connecting hole has a same size as the plurality of second locking holes; and said second adjusting part is inserted inside said plurality of second locking holes and said second connecting hole to form limit fixation.

10. The child toilet ladder according to claim 9, wherein said supporting rod is provided with a third connecting hole, said first adjusting part is inserted into said third connecting hole, and at least part of said main sleeve and said main rod is embedded in said supporting rod.

11. The child toilet ladder according to claim 10, wherein an upper pedal is also fixed at a joint of said height adjusting mechanism and said angle adjusting mechanism, and fourth connecting holes are symmetrically arranged at both ends of said upper pedal; and said fourth connecting holes have a same size as said first locking holes, and said upper pedal is connected and fixed with said height adjusting mechanism through said first adjusting part.

12. The child toilet ladder according to claim 11, wherein said main sleeve and said supporting rod are provided with limit blocks.

13. A child toilet ladder, comprising a ladder assembly and a cushion assembly, wherein said ladder assembly comprises a supporting platform, a height adjusting mechanism and an angle adjusting mechanism; and
wherein said height adjusting mechanism comprises a main sleeve and a main rod, wherein said main rod is provided with a plurality of first locking holes, and said main rod is inserted into said main sleeve and connectedly locked by a first adjusting part; and
wherein, said angle adjusting mechanism comprises a supporting sleeve and a supporting rod, wherein said supporting rod is provided with a plurality of second locking holes, said supporting sleeve is sleeved on said supporting rod, and is connectedly locked by a second adjusting part, and at least part of said supporting sleeve has an arc-shaped tubular structure; and
wherein, through said angle adjusting mechanism, said main sleeve is rotatably connected with said supporting platform, said supporting sleeve is detachably connected with said supporting platform, and said supporting rod is detachably connected with said height adjusting mechanism through said first adjusting part; and a stable triangular structure is formed among said supporting platform, said height adjusting mechanism and said angle adjusting mechanism, and said cushion assembly is rotatably connected with said main rod of said ladder assembly, so that said ladder assembly and said cushion assembly are detachably connected.

14. The child toilet ladder according to claim 13, wherein said cushion assembly comprises a toilet seat body, and one end of said toilet seat body is provided with a fifth connecting hole, and one end of said main rod is provided with a hinge hole, and said toilet seat body and said main rod are connected and fixed by a fastener, wherein said hinge hole is a chute structure, and said fifth connecting hole has a same size as said hinge hole.

15. The child toilet ladder according to claim 14, wherein at least four first fixing grooves are arranged on both sides of said toilet seat body, and armrests are connected through said at least four first fixing grooves, and first bumps are symmetrically arranged at both ends of said armrests, and said armrests and said toilet seat body are connected and fixed through said first bumps and said at least four first fixing grooves.

16. The child toilet ladder according to claim 15, wherein a cushion is added in said toilet seat body, said cushion is detachable, and an anti-slip pad is arranged at a bottom; and the anti-slip pad is in contact with a toilet to increase the stability of said cushion assembly, and said toilet seat body is connected with a backrest, and said backrest and said toilet seat body are detachably connected by buckling.

17. The child toilet ladder according to claim 16, wherein an adjustable heating device is arranged in said cushion and said heating device can adjust an appropriate temperature according to different temperature requirements of children, so that children are more comfortable to use, and at the same time, a safety device is added to said toilet seat body.

18. A method for allowing children to use an adult toilet, comprising providing a child toilet ladder, wherein
said child toilet ladder comprises a ladder assembly and a cushion assembly, wherein said ladder assembly comprises a supporting platform, a height adjusting mechanism and an angle adjusting mechanism; and
wherein said height adjusting mechanism comprises a main sleeve and a main rod, wherein said main rod is provided with a plurality of first locking holes, and said main rod is inserted into said main sleeve and connectedly locked by a first adjusting part; and
wherein, said angle adjusting mechanism comprises a supporting sleeve and a supporting rod, wherein said supporting rod is provided with a plurality of second locking holes, and said supporting sleeve is sleeved on said supporting rod and is connectedly locked by a second adjusting part; and
wherein, through said angle adjusting mechanism, said main sleeve is rotatably connected with said supporting platform, said supporting sleeve is detachably connected with said supporting platform, and said supporting rod is detachably connected with said height adjusting mechanism through said first adjusting part; and a stable triangular structure is formed among said supporting platform, said height adjusting mechanism and said angle adjusting mechanism, and said cushion assembly is rotatably connected with said main rod, so that said ladder assembly and said cushion assembly are detachably connected; and
the method comprises the following ladder:
placing said cushion assembly on a toilet; and
adjusting said child toilet ladder to a proper height relative to said toilet through said height adjusting mechanism; and
adjusting the child toilet ladder to an appropriate inclination angle relative to said toilet through said angle adjusting mechanism.

19. The method according to claim 18, wherein, before adjusting the height of said child toilet ladder, said supporting platform and said cushion assembly are respectively placed on the ground and the toilet stably, and appropriate height adjustment is made by said height adjusting mechanism according to a relative height distance between said supporting platform and said cushion assembly.

20. The method according to claim 18, wherein, before adjusting the angle of said child toilet ladder, said supporting platform and said cushion assembly are respectively placed on the ground and the toilet stably, and appropriate angle adjustment is performed by said angle adjusting mechanism according to a relative inclination angle between said supporting platform and said cushion assembly.
